(19) United States
(12) Patent Application Publication
(10) Pub. No.: US 2022/0356701 A1
(43) Pub. Date: Nov. 10, 2022

(54) METHOD AND DEVICE IN A FLOOR STRUCTURE DRYING PROCESS

(71) Applicant: Reddo Floor Solutions AB, Stockholm (SE)

(72) Inventor: Johan ÅHSBERG, Mollösund (SE)

(21) Appl. No.: 17/439,102

(22) PCT Filed: Apr. 8, 2020
(86) PCT No.: PCT/SE2020/050365

§ 371 Date: Sep. 14, 2021

(30) Foreign Application Priority Data
Apr. 9, 2019 (SE) 1930117-5

(51) Int. Cl. E04B 1/70; E04G 23/02

(52) U.S. Cl. CPC E04B 1/7092; E04G 23/0285

(57) ABSTRACT

A method and device for holding a subsurface layer of an elevated flooring portion of a floor structure at a distance from a subfloor in a vicinity of an opening in the flooring portion during a process of drying the floor structure. According to the invention there is provided at least one rod having a substantially perpendicularly angled end. The rod is inserted below the subsurface layer through the opening and the angled end of the rod is attached to an edge of a surface layer in the opening of the flooring portion in a manner that the rod supports the subsurface layer at said distance from the subfloor when the flooring portion is elevated.

### TECHNICAL FIELD

The present invention relates to a device and a method for mounting a beam layout when constructing a building and more specifically a building of wood.

### BACKGROUND

A beam layout is a supporting construction part, which from either the top or the bottom side, or both, delimits different storeys in a building.

The term beam layout occurs in many different combinations depending on its field of application and material. Examples of beam layout named after the material is wood beam layout and concrete beam layout. Examples of beam layout named after their function are floor beam layout, roof beam layout, storey beam layout and farm beam layout.

A common method in house construction involves the use of building blocks or building elements, such as wall blocks, floor blocks and beam layout blocks. The various blocks comprise a framework of bars, which are covered by a building plate or plaster plate on both sides in such a manner that a box is formed. The bars can be of solid wood, but can also comprise a kind of lightweight bar or lightweight beam. The lightweight beam comprises an oblong plate of building board, which at its long sides is provided with square bars of wood, an example of this is described in the Swedish application SE 0700202-5. This results in a bar that is lighter than a solid wooden bar, but with the same strength. The wall block plate covering the box constructed of the bars can comprise plaster, chipboard, OSB, plywood or similar board. The choice of plate is determined by the required strength as well as whether the plate is to form part of an external wall or an internal wall. If it relates to an exterior wall, this is provided with, for example, a wooden panel outside the board in the known way, and if it relates to an internal wall, this is provided with, for example, plaster plates on the outside of the board for the final finish. Before the plates are mounted on the framework, insulation can be placed between the bars, both as heat insulation and sound insulation. The beam layout element or the beam layout block is constructed in the same way as the wall block, but one of its upward facing building plate constitutes the floor plate and its downward facing building plate constitutes the ceiling.

The building elements can in a simple way quickly be mounted together to a building or a building module, also referred to as volume. A building module for example refers to a living room, which is completed before it is transported as a box or volume to the site, on which the building is to be constructed, whereafter several modules are mounted together to form a building. The advantage of using building elements is that they can be manufactured in a controlled indoor environment, which provides a damp-proof manufacturing with minimized risk of damage to insulation and building plates due to rain or snow. Wall blocks are for example manufactured with a width of between 1200 mm and 2400 mm and beam layouts with a width between 1200 mm and 2400 mm. The length of the beam layout element can be up to 10000 mm, but it should be noted that the length and the width can exceed these measures.

The building or volume is mounted by the beam layout elements and wall blocks being set up and connected at the edges and corners of the block. The beam layout element constitutes both the roof of a lower storey and the floor of an upper storey at the same time. A common way of building multi-storey houses is that the first storey is built according to the description above, whereafter the next layer or storey of wall blocks is set up on sound-absorbing bands or strips that are placed on the beam layout according to its edges. When these wall blocks are mounted together, a new layer of beam layout is placed on top of these walls. The connection or locking between the wall block and the beam layout can be established with studs. The studs are mounted at the edges of the beam layout, and the wall blocks are arranged with recesses or depressions for receiving the studs or vice versa. When the studs are placed in the recesses, the walls and the beam layout are locked against lateral movements.

The disadvantage of this method is that the more storeys to be built, the stronger forces affect the sound-absorbing bands. Finally, the sound insulation is squeezed together so much that its sound-absorbing effect is reduced. Yet another disadvantage of this method is if a strong pressure surge occurs at a lower storey level, for example in the event of an explosion. Such pressure surge can lift a beam layout somewhat, which may imply that the studs come out of the recess, which may cause the building to collapse.

A way of avoiding this is to mount the beam layout with hooks or corbels that are hung on the edges of the wall block, on the interior side of the wall block or on a bearer, an example of this is described in the Swedish application number SE0700202-5. When the beam layout is to be hung up, a sound-absorbing material is placed in the recesses arranged at the edge of the wall block. The hooks or corbels are fastened by screws in at the edge and/or bottom side of the beam layout. The beam layout is lifted in place with the corbels in the recesses. When the beam layout is in place, the wall block of the next storey can be placed on the edge of the previously arranged wall blocks, whereafter the method is repeated.

### SUMMARY OF THE INVENTION

The object of the invention is to achieve a device that offers a sound-damping/vibration-damping mounting of beam layouts in construction of a building. The device is intended to be placed between the building elements, whereby sound, which may arise from vibrations in the form of music, voices, steps or the like, can be limited or entirely removed.

### DESCRIPTION OF FIGURES

FIG. 1A shows and describes various types of building elements

FIG. 1B shows and describes an example of a vibration-damping device

FIGS. 2A-2D show further examples of vibration-damping devices, and

FIGS. 3A-3D show examples of various types of vibration-damping devices

### DESCRIPTION OF EMBODIMENTS

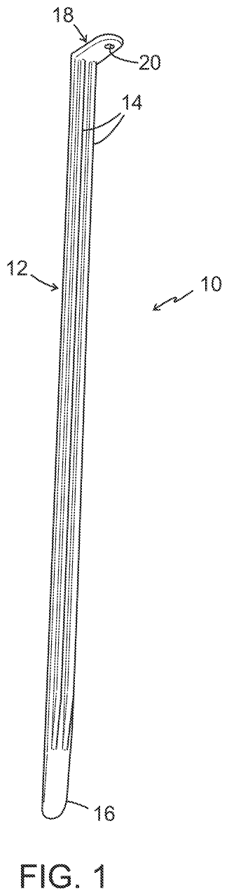

The building construction shown in FIG. 1A comprises a first and a second building element X in the form of a wall block 1, the vibration-damping device 2 as well as a building element in the form of a beam layout 3. The wall blocks 1 are stacked on each other with their end edges against each other, forming a wall 4. In connection with the joint 5 between the wall blocks 1A, 1B, a building element is placed in the form of a beam layout 3.

In an embodiment, the vibration-damping device 2 according to FIG. 1B is placed on a corbel 6 in the form of a bracket. The one corbel portion 7 is fixedly mounted on the wall block 1, in connection with the bracket 5 between two wall blocks 1A, 1B. The corbel 6 is configured with the one portion 7 directed in parallel with the wall 1 and the other portion 8 directed in parallel with the beam layout 3. The portion 7 that is parallel to the wall 1 is provided with screw holes 9 through which the corbel 6 can be fastened with screws in the wall 1. The portion 8 that is parallel to the beam layout 3 constitutes attachment for the vibration-damping device 2. Furthermore, the vibration-damping device 2 is provided with an attachment 10 with which the beam layout 3 can be attached to the vibration-damping portion 2.

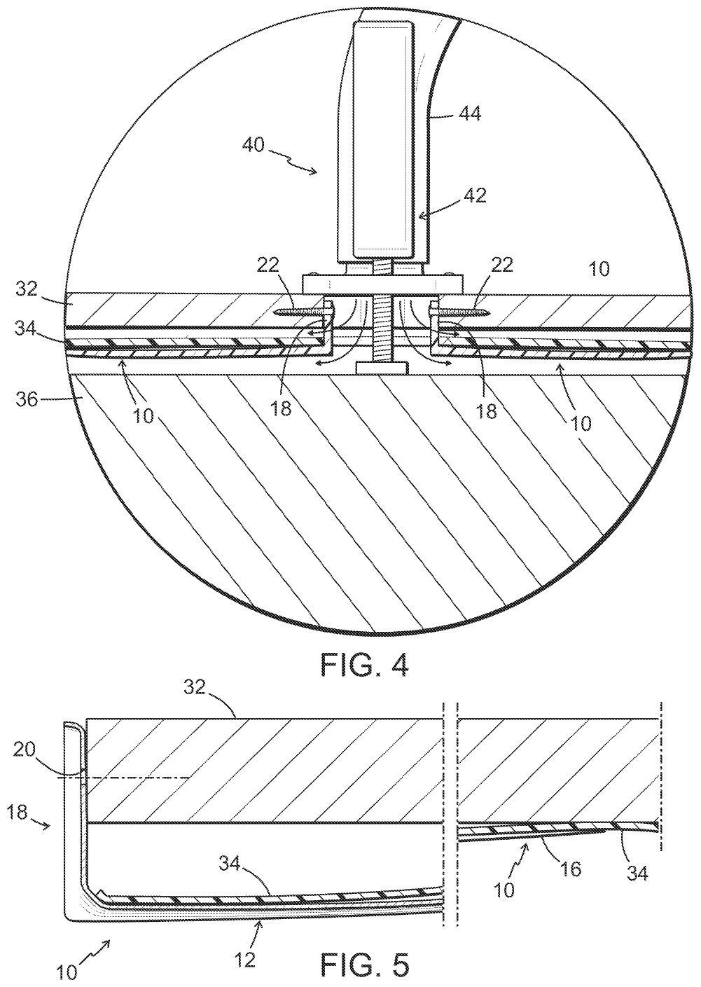

In another embodiment, shown in FIG. 3D, the corbel 6 comprises a portion 6A, which at mounting extends past the joint 5 between two wall blocks 1A, 1B. The corbel 6 is advantageously mounted, before the next wall block 1B, in the row of wall blocks placed on each other, is to be mounted on the first wall block's 1A end portion 11. In this manner, the corbel 6 forms an aligning means for the next wall block 1B, by the wall block's surface 12 being placed against the corbel portion 6A. Thus, the mounting of the wall block is facilitated.

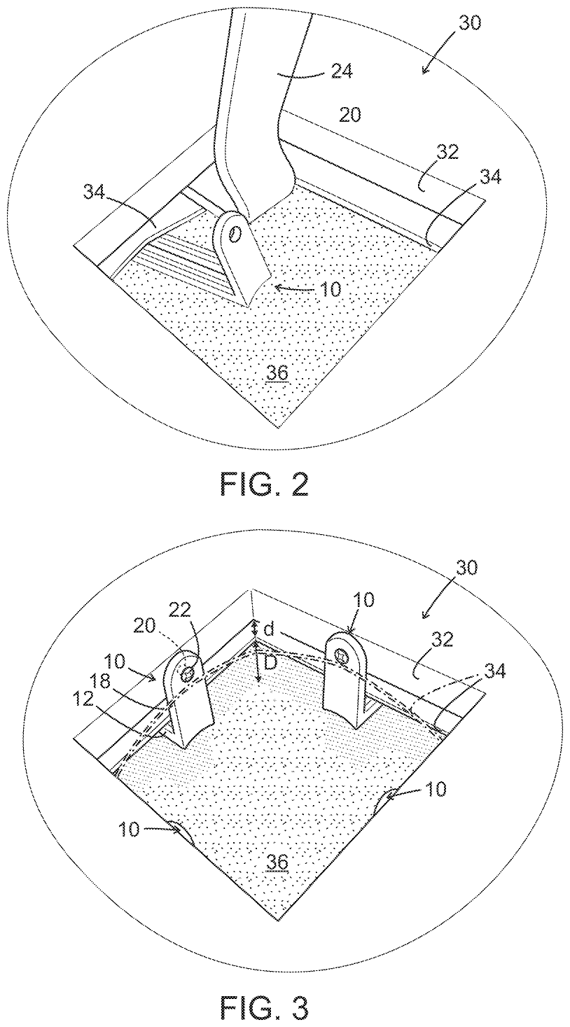

In another embodiment according to FIG. 2C, the vibration-damping device's 2 attachment comprises a second corbel 13 or a second bracket, with a portion 14 in parallel with the beam layout 3 and a second portion 15 in parallel with the wall 1, but extending along the beam layout's 3 end edge 16 or short side.

In another embodiment according to FIG. 2B, the vibration-damping device 2 is arranged between two parallel surfaces 17,18, the one surface 17 accommodated in the wall block 1 and the second surface 18 accommodated in the beam layout 3. The vibration-absorbing device 2 is mounted to one of the two surfaces 17,18 whereafter the beam layout 3 is placed with its parallel surface 18 against the wall block's parallel surface 17, whereby the vibration-absorbing device 2 is positioned between the surfaces.

According to FIG. 2D, the parallel surfaces 17, 18 can comprise a beam 19 of wood or metal or aluminium, which is mounted on the wall block's 1 surface 20. The beam 19 has a thickness, which is equal to or larger than the width of the vibration-damping device 2. Correspondingly, a similar beam 19 is mounted on the beam layout edge 16. Alternatively, the beam layout's 3 surface layer 21 in the form of a plate of laminated wood or thick building board projects outside the beam layout edge 16 according to FIG. 2A, whereby the protruding portion replaces the beam 19.

According to FIG. 3B, the vibration-damping device 2 is in its simplest form constituted by a piece of material 22 of a springy or resilient material, for example rubber, or by an elastomeric material, for example polyurethane. Alternatively, the piece of material can be replaced by a spiral spring 23, see FIG. 3A. Yet another alternative is to replace the piece of material by a so-called wave spring 24 as shown in an exemplified form in FIG. 3C. A wave spring comprises a single-turn or multi-turn ring 25 of a flat spring material, to which a wave form 26 is affixed along the entire ring. This gives a plurality of resilient and vibration-absorbing areas, which together can absorb vibrations in a relatively short extent of movement, which gives a reduced built-in height.

The vibration-damping device is fixed onto the corbel or the parallel surface according to FIGS. 1B and 3D by means of screws 27. A self-drilling screw is mounted first through the one side of the vibration-damping device to keep it in place on the one parallel surface or the corbel, before the beam layout is lifted into place. Subsequently, a second screw is screwed though the beam layout's surface layer or board in the second side of the device in such a manner that the device is fixed without being able to be moved from the location.

Whether corbels 6, 13 or beams 19 are used in combination with a piece of material 22, a spiral spring 23 or wave spring 24, a spring plate 28 can advantageously be placed between the parallel surfaces 8, 14, 17, 18, 21 and the springs 22, 23, 24. A self-drilling screw 27 is subsequently screwed through the corbel portion 8, 14 and through the spring plate 28. In this manner, a fixed mounting laterally is obtained, but with full freedom of movement in height for the spring. In another embodiment, the spring plate 28 comprises a container with a so-called chemical anchor 29. When the screw is screwed in, the components of the chemical anchor are activated, whereafter the anchor hardens and locks the screw. In yet another variant, the chemical anchor, for example in the form of a two-component adhesive, can be injected under the spring plate before the screw is screwed in, whereafter the chemical anchor hardens through contact with air.

If a spiral spring 23 or a wave spring 24 is used, a spring guide can advantageously be used. The guide can comprise a sleeve or a short piece of pipe, which sleeve or piece of pipe is attached to one or both parallel surfaces, before the spring is placed above the sleeve or piece of pipe. The guide has been given a diameter, which is somewhat smaller than the spring, and in this way prevents the spring from being moved from the parallel surface, when the vibration-damping device is mounted.

The present invention is not limited to the description above and what is shown in the drawings, but can be amended and modified in a number of different ways within the framework of the intention of the inventive idea set forth in the following claims.

1. A method of holding a subsurface layer of an elevated flooring portion of a floor structure at a distance from a subfloor in a vicinity of an opening in the flooring portion during a process of drying the floor structure, wherein
providing a rod having a substantially perpendicularly angled end;
inserting the rod below the subsurface layer through the opening; and
attaching the angled end of the rod to an edge of a surface layer in the opening of the flooring portion in a manner that the rod supports the subsurface layer at said distance from the subfloor when the flooring portion is elevated.

2. The method of claim 1, comprised by the attaching is by releasable fasteners.

3. The method of claim 1, comprised by the attaching is by screwing.

4. The method of claim 1, comprised by making the distance from the subfloor to the subsurface layer larger than a distance from the subsurface layer to the surface layer of the floor structure.

5. The method of claim 1, comprised by the distance from the subfloor to the subsurface layer is an average distance due to a flexible nature of the subsurface layer.

6. The method of claim 5, comprised by making said distance from the subfloor to the subsurface layer more than twice the distance from the subsurface layer to the surface layer.

7. A device for holding a subsurface layer of an elevated flooring portion of a floor structure at a distance from a subfloor in a vicinity of an opening in the flooring portion during a process of drying the floor structure, wherein
a rod having a substantially perpendicularly angled end to be attached to an edge of a surface layer in the opening of the flooring portion in a manner that the rod supports the subsurface layer at said distance from the subfloor when the flooring portion is elevated.

8. The device of claim 7, wherein the angled end has an aperture for attachment to the edge of the surface layer by a releasable fastener.

9. The device of claim 7, wherein the rod has a flattened main portion.

10. The device of claim 9, wherein a face of the flattened main portion is provided with a stiffening ridge.

11. The device of claim 7, wherein the rod has a tapered forward portion.
